(19) United States
(12) Patent Application Publication
(10) Pub. No.: US 2025/0128207 A1
(43) Pub. Date: Apr. 24, 2025

(54) CATALYTIC DEVICE

(71) Applicant: TOYOTA JIDOSHA KABUSHIKI KAISHA, Toyota-shi (JP)

(72) Inventor: Toshinori OKI, Toyota-shi (JP)

(73) Assignee: TOYOTA JIDOSHA KABUSHIKI KAISHA, Toyota-shi (JP)

(21) Appl. No.: 18/769,649

(22) Filed: Jul. 11, 2024

(30) Foreign Application Priority Data
Oct. 19, 2023 (JP) 2023-180305

(51) Int. Cl. B01D 53/94

(52) U.S. Cl. CPC B01D 53/945; B01D 2258/012; B01D 2259/122

(57) ABSTRACT

The catalytic device has a connection region, a first double pipe region, a triple pipe region, and a second double pipe region. The connection region, the first double pipe region, the triple pipe region, and the second double pipe region are arranged in this order from the upstream side toward the downstream side in the exhaust direction. A sealing member having heat insulating property is sandwiched between the inner pipe and the outer pipe in the second double pipe region. The passageway between the introduction pipe and the inner pipe in the triple pipe region, the passageway between the introduction pipe and the outer pipe in the first double pipe region, and the passageway between the inner pipe and the outer pipe in the triple pipe region are in communication.

### CROSS-REFERENCE TO RELATED APPLICATION

This application claims priority to Japanese Patent Application No. 2023-180305 filed on Oct. 19, 2023, incorporated herein by reference in its entirety.

### BACKGROUND

### 1. Technical Field

The disclosure relates to a catalytic device.

### 2. Description of Related Art

Japanese Unexamined Patent Application Publication No. 2023-058325 (JP 2023-058325 A) describes a catalytic device disposed in an exhaust passage of an internal combustion engine. The catalytic device includes a catalyst heated by application of electricity, a case accommodating the catalyst, and an introduction pipe for introducing exhaust gas from the internal combustion engine into the case.

In JP 2023-058325 A, the case has a double pipe structure, having an inner pipe accommodating the catalyst and an outer pipe situated on an outer periphery of the inner pipe. With a direction in which the exhaust gas flows from the introduction pipe toward the catalyst as an exhaust direction, an end portion of the outer pipe on an upstream side in the exhaust direction is connected to an outer peripheral face of the introduction pipe. An end portion of the outer pipe on a downstream side in the exhaust direction is connected to an outer peripheral face of the inner pipe.

In a catalytic device having a case with such a double pipe structure, the inner pipe is exposed to exhaust gas, while the outer pipe is exposed to not only the exhaust gas but also outside air. Thus, the outer pipe is cooler than the inner pipe. Accordingly, particulate matter floating between the outer peripheral face of the inner pipe and an inner peripheral face of the outer pipe is attracted to the inner peripheral face of the outer pipe by thermophoresis. As a result, the particulate matter is less likely to adhere to the outer peripheral face of the inner pipe. Hereinafter, particulate matter will be referred to as “PM”.

### SUMMARY

Heat of the catalyst is transferred to the inner pipe and thereafter transferred to the outer pipe at a connection point between the inner pipe and the outer pipe. Consequently, temperature difference between the inner pipe and the outer pipe becomes small, and accordingly the thermophoresis effect may deteriorate.

In order to solve the above problem, a catalytic device includes
a catalyst that is heated by application of electricity,
a case including an inner pipe accommodating the catalyst and an outer pipe that is situated on an outer periphery of the inner pipe, and
an introduction pipe for introducing exhaust gas that is discharged from an internal combustion engine into the case.

With a direction in which the exhaust gas flows from the introduction pipe toward the catalyst as an exhaust direction, an end portion of the inner pipe on an upstream side in the exhaust direction is situated further on the upstream side in the exhaust direction from an end face of the catalyst on the upstream side in the exhaust direction.

An end portion of the outer pipe on the upstream side in the exhaust direction is situated further on the upstream side in the exhaust direction from the end portion of the inner pipe on the upstream side in the exhaust direction.

An end portion of the introduction pipe on a downstream side in the exhaust direction is inserted inside the inner pipe.

The catalytic device includes a connection region in which the introduction pipe and the outer pipe are connected.

The catalytic device includes a first double pipe region. The first double pipe region is situated further on the downstream side in the exhaust direction than the connection region. The first double pipe region is a region in which the introduction pipe and the outer pipe overlap in a state of being distanced from each other in a radial direction.

The catalytic device includes a triple pipe region. The triple pipe region is situated further on the downstream side in the exhaust direction than the first double pipe region. The triple pipe region is a region in which the introduction pipe, the inner pipe, and the outer pipe overlap in a state of being distanced from each other in the radial direction.

The catalytic device includes a second double pipe region. The second double pipe region is situated further on the downstream side in the exhaust direction than the triple pipe region. The second double pipe region is a region in which the inner pipe and the outer pipe overlap in a state of being distanced from each other in the radial direction.

A sealing member with heat insulating properties is interposed between the inner pipe and the outer pipe in the second double pipe region.

A passage between the introduction pipe and the inner pipe in the triple pipe region, a passage between the introduction pipe and the outer pipe in the first double pipe region, and a passage between the inner pipe and the outer pipe in the triple pipe region, communicate.

According to the disclosure, temperature difference between the inner pipe and the outer pipe increases, and accordingly the thermophoresis effect can be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an internal combustion engine, an exhaust passage, and a catalytic device; and

FIG. 2 is a cross-sectional view of a catalytic device.

### DETAILED DESCRIPTION OF EMBODIMENTS

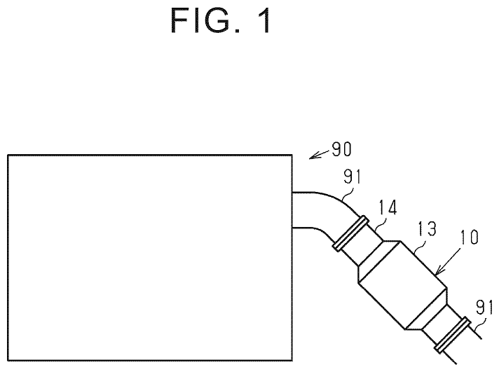

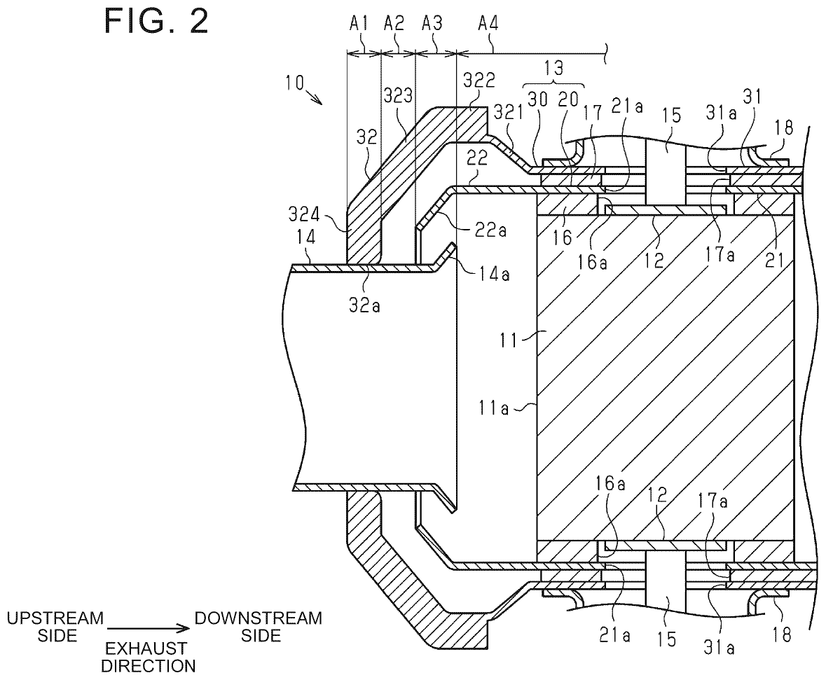

Hereinafter, an embodiment embodying the catalytic device will be described with reference to FIGS. 1 and 2.

FIG. 1 shows an internal combustion engine 90 of a vehicle, an exhaust passage 91 connected to the internal combustion engine 90, and a catalytic device 10 arranged in the middle of the exhaust passage 91. The internal combustion engine 90 of the present embodiment is a gasoline engine. The exhaust gas discharged from the internal combustion engine 90 flows through the exhaust passage 91. The catalytic device 10 reduces exhaust. The catalytic device 10 is an electrically heated catalytic device in which a catalyst is heated by energization.

### Configuration of Catalytic Device

As illustrated in FIG. 2, the catalytic device 10 includes a catalyst 11, a pair of electrodes 12 for energizing the catalyst 11, a case 13 containing the catalyst 11, and an introduction pipe 14 for introducing exhaust gas from the internal combustion engine 90 into the case 13. Hereinafter, a direction in which the exhaust gas flows from the introduction pipe 14 toward the catalyst 11 is referred to as an exhaust direction.

The catalyst 11 of the present embodiment has a cylindrical shape. Although not shown, the catalyst 11 includes a catalyst support and a catalyst body supported on the catalyst support. The catalyst support is a porous body. The catalyst support has, for example, a honeycomb structure in which a plurality of passages extending in the axial direction of the catalyst 11 are partitioned. The catalyst support is made of a material that generates heat by becoming an electrical resistance when energized. The catalyst support of the present embodiment is made of silicon carbide. The catalyst body of the present embodiment is a three-way catalyst. The catalyst body may be an oxidation catalyst, a selective reduction catalyst, or the like.

The pair of electrodes 12 is attached to the outer peripheral surface of the catalyst 11. In the present embodiment, the pair of electrodes 12 are arranged at positions shifted by 180 degrees in the circumferential direction of the catalyst 11. A pair of leads 15 extend from the pair of electrodes 12. By applying a voltage between the pair of electrodes 12, a current flows through the catalyst 11. When a current flows through the catalyst 11, the electric resistance of the catalyst 11 causes the catalyst 11 to generate heat.

The case 13 is a double pipe structure having an inner pipe 20 and an outer pipe 30 located on the outer periphery of the inner pipe 20. The inner pipe 20 and the outer pipe 30 are each made of metal. The inner pipe 20 and the outer pipe 30 of the present embodiment are each made of stainless steel. The inner pipe 20 contains the catalyst 11. The axial direction of the inner pipe 20 and the axial direction of the catalyst 11 coincide with each other.

A mat 16 is disposed between the outer peripheral surface of the catalyst 11 and the inner peripheral surface of the inner pipe 20. The mat 16 is sandwiched between the catalyst 11 and the inner pipe 20 in a compressed state. The catalyst 11 is held in the inner pipe 20 by the restoring force of the compressed mat 16. The mat 16 is made of an insulating material. Therefore, the mat 16 has an insulating property. The mat 16 of the present embodiment is made of an inorganic fiber containing alumina as a main component. As a result, when a current flows through the catalyst 11, it is avoided that a current also flows through the inner pipe 20 via the mat 16.

The mat 16 of the present embodiment is annular. The mat 16 is disposed over the entire circumference of the catalyst 11 and the inner pipe 20 in the circumferential direction. Two insertion holes 16a are formed in the mat 16. The two insertion holes 16a are arranged at positions shifted by 180 degrees in the circumferential direction of the mat 16.

The inner pipe 20 has an accommodation portion 21 located on the outer periphery of the catalyst 11, and an upstream portion 22 located on the upstream side in the exhaust direction from the upstream end face in the exhaust direction of the catalyst 11. Hereinafter, the upstream end face of the catalyst 11 in the exhaust direction is referred to as an “upstream end face 11a”. Two insertion holes 21a are formed in the accommodation portion 21. The two insertion holes 21a are arranged at positions shifted by 180 degrees in the circumferential direction of the inner pipe 20. An insulating portion (not shown) is provided on the inner peripheral surface and the outer peripheral surface of the upstream portion 22. The insulating portion is formed by applying an insulating material to the inner peripheral surface and the outer peripheral surface of the upstream portion 22 of the inner pipe 20. The insulating material of the present embodiment is glass.

The upstream portion 22 includes an end portion on the upstream side in the exhaust direction of the inner pipe 20. Hereinafter, the upstream end portion of the inner pipe 20 in the exhaust direction is referred to as an “upstream end portion 22a”. As described above, the upstream portion 22 is a portion located on the upstream side of the upstream end face 11a of the catalyst 11 in the exhaust direction. Therefore, the upstream end portion 22a is located upstream of the upstream end face 11a of the catalyst 11 in the exhaust direction.

The upstream end portion 22a of the inner pipe 20 of the present embodiment is a reduced diameter portion whose inner diameter decreases from the downstream side toward the upstream side in the exhaust direction.

The outer pipe 30 is radially spaced apart from the inner pipe 20. The outer peripheral surface of the outer pipe 30 is exposed to the outside air. The outer pipe 30 has an accommodation portion 31 positioned on the outer periphery of the catalyst 11, and an upstream portion 32 positioned on the upstream side of the upstream end face 11a of the catalyst 11 in the exhaust direction.

Two insertion holes 31a are formed in the accommodation portion 31. The two insertion holes 31a are arranged at positions shifted by 180 degrees in the circumferential direction of the outer pipe 30. The upstream portion 32 includes an upstream end portion of the outer pipe 30 in the exhaust direction. Hereinafter, the upstream end of the outer pipe 30 in the exhaust direction is referred to as an “upstream end portion 32a”. The upstream end portion 32a of the outer pipe 30 is located upstream of the upstream end portion 22a of the inner pipe 20 in the exhaust direction.

The upstream portion 32 of the outer pipe 30 of the present embodiment includes a first portion 321, a second portion 322, a third portion 323, and a fourth portion 324. The inner diameter of the first portion 321 increases from the downstream side toward the upstream side in the exhaust direction. The second portion 322 is located upstream of the first portion 321 in the exhaust direction. The second portion 322 extends along the axial direction of the outer pipe 30. The third portion 323 is located upstream of the second portion 322 in the exhaust direction. The inner diameter of the third portion 323 decreases from the downstream side toward the upstream side in the exhaust direction. The third portion 323 extends parallel to the upstream end portion 22a of the inner pipe 20. The fourth portion 324 is located upstream of the third portion 323 in the exhaust direction. The fourth portion 324 extends along the radial direction of the outer pipe 30. In the present embodiment, the thickness of the outer pipe 30 in the first portion 321 is the same as the thickness of the outer pipe 30 in the accommodation portion 31. The thickness of the outer pipe 30 in each of the second portion 322, the third portion 323, and the fourth portion 324 is larger than the thickness of the outer pipe 30 in the first portion 321.

The introduction pipe 14 is made of metal. The introduction pipe 14 of the present embodiment is made of stainless steel. An end portion of the introduction pipe 14 on the downstream side in the exhaust direction is inserted inside the inner pipe 20. Hereinafter, the downstream end portion of the introduction pipe 14 in the exhaust direction is referred to as a “downstream end portion 14a”. The downstream end portion 14a of the introduction pipe 14 overlaps with the upstream end portion 22a of the inner pipe 20 with a radial distance therebetween. In the present embodiment, the downstream end portion 14a of the introduction pipe 14 is an enlarged-diameter portion whose inner diameter increases from the upstream side toward the downstream side in the exhaust direction. The downstream end portion 14a of the introduction pipe 14 extends parallel to the upstream end portion 22a of the inner pipe 20.

The upstream end portion 32a of the outer pipe 30 is joined to the outer peripheral surface of the introduction pipe 14. In the present embodiment, the upstream end portion 32a of the outer pipe 30 is welded to the outer peripheral surface of the introduction pipe 14. As described above, the upstream end portion 32a of the outer pipe 30 is located upstream of the upstream end portion 22a of the inner pipe 20 in the exhaust direction. Therefore, the joint position between the outer pipe 30 and the introduction pipe 14 is located upstream of the upstream end portion 22a of the inner pipe 20 in the exhaust direction.

The catalytic device 10 includes a connecting region A1, a first double pipe region A2, a triple pipe region A3, and a second double pipe region A4. The connecting region A1 is a region where the introduction pipe 14 and the outer pipe 30 are connected to each other. The first double pipe region A2 is located downstream of the connecting region A1 in the exhaust direction. The first double pipe region A2 is a region where the introduction pipe 14 and the outer pipe 30 overlap with each other with a radial distance therebetween. The triple pipe region A3 is located downstream of the first double pipe region A2 in the exhaust direction. The triple pipe region A3 is a region in which the introduction pipe 14, the inner pipe 20, and the outer pipe 30 are radially separated from each other. The second double pipe region A4 is located downstream of the triple pipe region A3 in the exhaust direction. The second double pipe region A4 is a region in which the inner pipe 20 and the outer pipe 30 are radially separated from each other.

The sealing member 17 is sandwiched between the outer peripheral surface of the inner pipe 20 and the inner peripheral surface of the outer pipe 30 in the second double pipe region A4. The sealing member 17 is sandwiched between the inner pipe 20 and the outer pipe 30 in a compressed state. The inner pipe 20 is held in the outer pipe 30 by the restoring force of the compressed sealing member 17. The sealing member 17 is made of an insulating material. The sealing member 17 is made of a heat insulating material. Therefore, the sealing member 17 has an insulating property and a heat insulating property. The sealing member 17 of the present embodiment is made of an inorganic fiber containing alumina as a main component. That is, the material of the sealing member 17 of the present embodiment is the same as the material of the mat 16.

In the present embodiment, the sealing member 17 is disposed on the downstream side of the upstream end face 11a of the catalyst 11 in the exhaust direction in the second double pipe region A4. Specifically, the sealing member 17 is sandwiched between the accommodation portion 21 of the inner pipe 20 and the accommodation portion 31 of the outer pipe 30. The passage between the accommodation portion 21 of the inner pipe 20 and the accommodation portion 31 of the outer pipe 30 is sealed by a sealing member 17. The sealing member 17 is not sandwiched between the upstream portion 22 of the inner pipe 20 and the upstream portion 32 of the outer pipe 30. The passageway between the upstream portion 22 of the inner pipe 20 and the upstream portion 32 of the outer pipe 30 is not sealed by the sealing member 17.

The sealing member 17 of the present embodiment is annular. The sealing member 17 is disposed over the entire circumference of the inner pipe 20 and the outer pipe 30 in the circumferential direction. Two insertion holes 17a are formed in the scaling member 17. The two insertion holes 17a are arranged at positions shifted by 180 degrees in the circumferential direction of the sealing member 17.

The insertion hole 16a of the mat 16, the insertion hole 21a of the inner pipe 20, the insertion hole 17a of the sealing member 17, and the insertion hole 31a of the outer pipe 30 radially overlap each other. A pair of terminal holders 18 are fixed to the outer pipe 30. The terminal holder 18 holds a terminal (not shown). The terminal holder 18 has a cylindrical shape. The terminal holder 18 is welded to the outer peripheral surface of the outer pipe 30 so as to surround the insertion hole 31a of the outer pipe 30. The lead 15 is drawn out to the outside of the case 13 through the insertion holes 16a, 21a, 17a, 31a. The lead 15 is separated from a surface of the inner pipe 20 that partitions the insertion hole 21a and a surface of the outer pipe 30 that partitions the insertion hole 31a. As a result, when the current flows through the lead 15, the current is prevented from flowing through the inner pipe 20 and the outer pipe 30. The leading end of the lead 15 is welded to the terminal inside the terminal holder 18.

The sealing member 17 is not sandwiched between the introduction pipe 14 and the inner pipe 20 in the triple pipe region A3, between the introduction pipe 14 and the outer pipe 30 in the first double pipe region A2, and between the inner pipe 20 and the outer pipe 30 in the triple pipe region A3. Thus, the passages between the introduction pipe 14 and the inner pipe 20 in the triple pipe region A3, the passages between the introduction pipe 14 and the outer pipe 30 in the first double pipe region A2, and the passages between the inner pipe 20 and the outer pipe 30 in the triple pipe region A3 are in communication. The passage between the introduction pipe 14 and the inner pipe 20 in the triple pipe region A3, the passage between the introduction pipe 14 and the outer pipe 30 in the first double pipe region A2, and the passage between the inner pipe 20 and the outer pipe 30 in the triple pipe region A3 constitute a labyrinth configuration.

As described above, in the present embodiment, in the second double pipe region A4, the sealing member 17 is not sandwiched between the upstream portion 22 of the inner pipe 20 and the upstream portion 32 of the outer pipe 30. Therefore, the passage between the inner pipe 20 and the outer pipe 30 in the triple pipe region A3 communicates with the passage between the upstream portion 22 of the inner pipe 20 and the upstream portion 32 of the outer pipe 30 in the second double pipe region A4.

### Exhaust Gas Flow

The flow of the exhaust gas in the catalytic device 10 will be described. The exhaust gas flowing into the case 13 from the introduction pipe 14 passes through the catalyst 11. At this time, a part of the exhaust gas flowing into the case 13 from the introduction pipe 14 collides with the upstream end face 11a of the catalyst 11, and flows from the downstream side toward the upstream side in the exhaust direction. That is, a part of the exhausted gas flowing into the case 13 is caused to flow backward by colliding with the upstream end face 11a of the catalyst 11.

The regurgitated exhaust gas flows into the passage between the introduction pipe 14 and the inner pipe 20 in the triple pipe region A3. Exhaust gas that has passed through the passage between the introduction pipe 14 and the inner pipe 20 in the triple pipe region A3 flows into the passage between the introduction pipe 14 and the outer pipe 30 in the first double pipe region A2. The exhaust gas flowing into the passage between the introduction pipe 14 and the outer pipe 30 in the first double pipe region A2 collides with the outer pipe 30, thereby changing the direction of the flow from the upstream side toward the downstream side in the exhaust direction. A portion of the diverted exhaust gas flows into the passageway between the inner pipe 20 and the outer pipe 30 in the triple pipe region A3. In the present embodiment, the exhaust gas that has passed through the passage between the inner pipe 20 and the outer pipe 30 in the triple pipe region A3 flows into the passage between the upstream portion 22 of the inner pipe 20 and the upstream portion 32 of the outer pipe 30 in the second double pipe region A4.

In this way, in the inner pipe 20, both the inner peripheral surface and the outer peripheral surface are exposed to the exhaust gas. On the other hand, in the outer pipe 30, the inner peripheral surface is exposed to the exhaust gas, but the outer peripheral surface is exposed to the outside air. Thus, the outer pipe 30 is cooler than the inner pipe 20. Thus, PM floating between the outer peripheral surface of the inner pipe 20 and the inner peripheral surface of the outer pipe 30 is attracted to the inner peripheral surface of the outer pipe 30 by thermophoresis. Consequently, PM is less likely to adhere to the outer peripheral surface of the inner pipe 20.

### Operation and Effect of the Present Embodiment

A description will now be made on action and effects of this embodiment. (1) Since the sealing member 17 having heat insulating property is sandwiched between the inner pipe 20 and the outer pipe 30, heat is less likely to be transferred from the inner pipe 20 to the outer pipe 30. This increases the temperature difference between the inner pipe 20 and the outer pipe 30. In addition, since the labyrinth configuration is configured by the first double pipe region A2 and the triple pipe region A3, it is difficult for the exhaust gas to flow between the inner pipe 20 and the outer pipe 30. This also increases the temperature difference between the inner pipe 20 and the outer pipe 30. By increasing the temperature difference between the inner pipe 20 and the outer pipe 30, the thermophoresis effect can be increased. Therefore, the quantity of PM adhering to the outer peripheral surface of the inner pipe 20 is reduced. As a consequence, an electric short circuit between the catalyst 11 and the case 13 through PM is less likely to occur, and thus the insulating property of the case 13 is improved.

(2) The sealing member 17 is arranged in the second double pipe region A4. Therefore, compared with the case where the sealing member 17 is also disposed between the inner pipe 20 and the outer pipe 30 in the triple pipe region A3, it is possible to increase the space in which PM moves due to thermophoresis. In addition, since the material of the sealing member 17 can be reduced, the cost of the catalytic device 10 can be reduced.

(3) As a configuration for improving the insulating property of the case 13, for example, by making the upstream portion 22 of the inner pipe 20 longer in the axial direction of the inner pipe 20, it is conceivable to increase the area of the insulating portion provided in the upstream portion 22. However, in this case, since the case 13 is enlarged in the axial direction of the inner pipe 20, the mountability of the catalytic device 10 on the vehicle is reduced.

On the other hand, in the present embodiment, the insulating property of the case 13 is improved by reducing the quantity of PM adhering to the outer peripheral surface of the inner pipe 20 by increasing the thermophoresis. In this case, since the length of the upstream portion 22 of the inner pipe 20 does not need to be longer in the axial direction of the inner pipe 20, the size of the case 13 can be reduced in the axial direction of the inner pipe 20. Therefore, the mountability of the catalytic device 10 on the vehicle is improved.

(4) As a configuration for increasing the temperature difference between the inner pipe 20 and the outer pipe 30, for example, it is conceivable to cool the outer pipe 30 by forming a cooling flow path through which coolant flows inside the outer pipe 30. However, in this case, the structure of the outer pipe 30 is complicated, and the outer pipe 30 is enlarged in the radial direction. On the other hand, in the present embodiment, the temperature difference between the inner pipe 20 and the outer pipe 30 is increased by the sealing member 17 and the labyrinth structure. Therefore, it is possible to avoid the complication of the structure of the outer pipe 30 due to the formation of the cooling flow path and the increase in the size of the outer pipe 30 in the radial direction.

(5) The downstream end portion 14a of the introduction pipe 14 is an enlarged-diameter portion whose inner diameter increases from the upstream side toward the downstream side in the exhaust direction. As a result, the exhaust gas flowing backward by colliding with the catalyst 11 easily collides with the downstream end portion 14a of the introduction pipe 14, so that the exhaust gas is less likely to flow between the introduction pipe 14 and the inner pipe 20. Therefore, since the exhaust gas is less likely to flow into the space between the inner pipe 20 and the outer pipe 30, the temperature difference between the inner pipe 20 and the outer pipe 30 becomes larger, so that the thermophoretic effect is further increased. When the flow rate of the exhaust gas is large, PM easily flows to the vicinity of the sealing member 17 due to the flow of the exhaust gas. In the present embodiment, since the downstream end portion 14a of the introduction pipe 14 is the enlarged-diameter portion, the flow path cross-sectional area at the outlet of the introduction pipe 14 is increased, so that the flow velocity of the exhausted gas is reduced. Therefore, it is difficult for PM to flow to the vicinity of the sealing member 17, so that it is possible to increase the duration for which PM moves by thermophoresis. As described above, PM can be effectively prevented from adhering to the outer peripheral surface of the inner pipe 20 by further increasing the thermophoresis effect and increasing PM transfer time by the thermophoresis.

(6) The sealing member 17 is disposed downstream of the upstream end face 11a of the catalyst 11 in the exhaust direction. As a result, PM can be moved more by thermophoresis than when the sealing member 17 is disposed on the upstream side of the upstream end face 11a of the catalyst 11 in the exhaust direction. Further, it is possible to increase the space in which the insulating portion can be formed with respect to the outer peripheral surface of the inner pipe 20.

(7) The scaling member 17 is made of an inorganic fiber containing alumina as a main component. Therefore, the sealing member 17 has a heat insulating property and an insulating property. Therefore, heat is less likely to be transferred from the inner pipe 20 to the outer pipe 30, and the inner pipe 20 and the outer pipe 30 can be electrically insulated from each other.

(8) The material of the sealing member 17 is the same as that of the mat 16. Therefore, the material of the mat 16 can also be diverted to the sealing member 17. (9) The upstream end portion 22a of the inner pipe 20 is a reduced diameter portion whose inner diameter decreases from the downstream side toward the upstream side in the exhaust direction. Thus, the exhaust gas that has flowed into the passage between the introduction pipe 14 and the inner pipe 20 in the triple pipe region A3 is likely to collide with the upstream end portion 22a of the inner pipe 20, the exhaust gas is less likely to flow into the passage between the introduction pipe 14 and the outer pipe 30 at that point. Therefore, since the exhaust gas is less likely to flow into the space between the inner pipe 20 and the outer pipe 30, the temperature difference between the inner pipe 20 and the outer pipe 30 becomes larger, so that the thermophoretic effect is further increased.

(10) The thickness of the outer pipe 30 in each of the second portion 322 to the fourth portion 324 of the upstream portion 32 of the outer pipe 30 is larger than the thickness of the outer pipe 30 in the first portion 321 and the accommodation portion 31 of the upstream portion 32. As a result, the heat capacity of the outer pipe 30 is increased, so that the outer pipe 30 is less likely to be warmed by the exhaust gas. Therefore, the thermophoresis effect can be further increased by increasing the temperature difference between the inner pipe 20 and the outer pipe 30.

(11) The outer pipe 30 has an accommodation portion 31 and an upstream portion 32. As a result, the heat capacity of the outer pipe 30 is increased as compared with the case where the outer pipe 30 has only the upstream portion 32, and thus the outer pipe 30 is less likely to be warmed by the exhaust gas. Therefore, the thermophoresis effect can be further increased by increasing the temperature difference between the inner pipe 20 and the outer pipe 30.

### Modifications

Note that the above-described embodiment can be modified as follows. The above-described embodiments and the following modifications can be implemented in combination with each other as long as they are not technically contradictory.
The internal combustion engine 90 is not limited to a gasoline engine. The internal combustion engine 90 may be, for example, a diesel engine or a hydrogen engine.
The catalytic device 10 may further include a catalyst other than the catalyst 11 of the above-described embodiment. That is, the catalytic device 10 may include a plurality of catalysts including the electrically heated catalyst 11. The catalyst to be added may be an exhaust purification member in which the catalyst body is not supported on the catalyst support, for example, a filter that collects particulate matter in the exhaust gas.
The method of joining the outer pipe 30 and the introduction pipe 14 is not limited to welding. The outer pipe 30 and the introduction pipe 14 may be bonded to each other by, for example, adhesive bonding or caulking.
The upstream end portion 22a of the inner pipe 20 may not be a reduced diameter portion.
The outer pipe 30 may not have the accommodation portion 31.
The shape of the upstream portion 32 of the outer pipe 30 may be changed as appropriate.
The downstream end portion 14a of the introduction pipe 14 may not be an enlarged-diameter portion.
The sealing member 17 may be disposed on the upstream side of the upstream end face 11a of the catalyst 11 in the exhaust direction in the second double pipe region A4.
The material of the mat 16 is not limited to inorganic fibers based on alumina.
The material of the sealing member 17 is not limited to an inorganic fiber containing alumina as a main component.
The material of the sealing member 17 may be different from the material of the mat 16.
The sealing member 17 may not be annular. The sealing member 17 may have, for example, a sheet shape. In this case, the sealing member 17 is wound around the outer peripheral surface of the inner pipe 20 over the entire circumference of the inner pipe 20.

What is claimed is:

1. A catalytic device comprising:
a catalyst that is heated by application of electricity;
a case including an inner pipe and an outer pipe, the inner pipe accommodating the catalyst, and the outer pipe being situated on an outer periphery of the inner pipe; and
an introduction pipe for introducing exhaust gas that is discharged from an internal combustion engine into the case, wherein:
with a direction in which the exhaust gas flows from the introduction pipe toward the catalyst as an exhaust direction, an end portion of the inner pipe on an upstream side in the exhaust direction is situated further on the upstream side in the exhaust direction from an end face of the catalyst on the upstream side in the exhaust direction;
an end portion of the outer pipe on the upstream side in the exhaust direction is situated further on the upstream side in the exhaust direction from the end portion of the inner pipe on the upstream side in the exhaust direction;
an end portion of the introduction pipe on a downstream side in the exhaust direction is inserted inside the inner pipe;
the catalytic device includes a connection region in which the introduction pipe and the outer pipe are connected;
the catalytic device includes a first double pipe region, the first double pipe region being situated further on the downstream side in the exhaust direction than the connection region, and the first double pipe region being a region in which the introduction pipe and the outer pipe overlap in a state of being distanced from each other in a radial direction;
the catalytic device includes a triple pipe region, the triple pipe region being situated further on the downstream side in the exhaust direction than the first double pipe region, and the triple pipe region being a region in which the introduction pipe, the inner pipe, and the outer pipe overlap in a state of being distanced from each other in the radial direction;
the catalytic device includes a second double pipe region, the second double pipe region being situated further on the downstream side in the exhaust direction than the triple pipe region, and the second double pipe region being a region in which the inner pipe and the outer pipe overlap in a state of being distanced from each other in the radial direction;
a sealing member with heat insulating properties is interposed between the inner pipe and the outer pipe in the second double pipe region; and
a passage between the introduction pipe and the inner pipe in the triple pipe region, a passage between the introduction pipe and the outer pipe in the first double pipe region, and a passage between the inner pipe and the outer pipe in the triple pipe region, communicate.

2. The catalytic device according to claim 1, wherein the end portion of the introduction pipe on the downstream side in the exhaust direction is an enlarged-diameter portion of which an inner diameter increases from the upstream side toward the downstream side in the exhaust direction.

3. The catalytic device according to claim 1, wherein the sealing member is disposed on the downstream side in the exhaust direction from the end face of the catalyst on the upstream side in the exhaust direction.

4. The catalytic device according to claim 1, wherein the sealing member made of an inorganic fiber of which alumina is a primary component.
